(19) United States
(12) Patent Application Publication
(10) Pub. No.: US 2016/0310900 A1
(43) Pub. Date: Oct. 27, 2016

(54) SUBMERGED MEMBRANE DISTILLATION FOR DESALINATION OF WATER

(71) Applicant: KING ABDULLAH UNIVERSITY OF SCIENCE AND TECHNOLOGY, Thuwal (SA)

(72) Inventors: Lijo FRANCIS, Thuwal (SA); Noreddine GHAFFOUR, Thuwal (SA); Ahmad ALSAADI, Thuwal (SA)

(21) Appl. No.: 15/135,646

(22) Filed: Apr. 22, 2016

Related U.S. Application Data
(60) Provisional application No. 62/152,061, filed on Apr. 24, 2015.

(51) Int. Cl. B01D 61/36; B01D 71/36; B01D 63/08; C02F 1/04; B01D 63/02

(52) U.S. Cl. CPC B01D 61/366; C02F 1/04; B01D 63/02; B01D 63/08; B01D 71/36; B01D 2325/38; C02F 2101/10

(57) ABSTRACT

Submerged membrane modules for use for desalination of water are disclosed. In one or more aspects, the membrane modules can be submerged either in a feed solution tank or the feed solution can pass through the lumen side of the membrane submerged within the tank. The feed solution can be a water-based feed stream containing an amount of salt.

### CROSS-REFERENCE TO RELATED APPLICATION

This application claims the benefit of and priority to U.S. Provisional Patent Application No. 62/152,061 entitled “Submerged Membrane Distillation for Desalination of Water” filed on Apr. 24, 2015, which is expressly incorporated by reference as if fully set forth herein in its entirety.

### CROSS-REFERENCE TO RELATED DOCUMENTS

This application makes reference to and incorporates by reference the following papers as if they were fully set forth herein expressly in its entirety: 1) Lijo Francis, Ahmad S AlSaadi, Noreddine Ghaffour Gary Amy, Submerged membrane distillation for seawater desalination. Conference and exhibition on Desalination for the Environment, Clean Water and Energy. 11-15 May 2014 Limassol, Cyprus; and 2) Lijo Francis, Noreddine Ghaffour, Ahmad S. Al-Saadi &

Gary Lee Amy (2014): Submerged membrane distillation for seawater desalination, Desalination and Water Treatment, DOI: 10.1080/19443994.2014.946716.

### TECHNICAL FIELD

The present disclosure generally relates to fresh water production from seawater, brines, brackish water and the like.

### BACKGROUND

Conventional desalination technologies such as multi-stage flash distillation (MSF) and reverse osmosis (RO) are not only highly energy intensive processes but also they require huge investment cost and a large footprint.

### SUMMARY

The present disclosure addresses the aforementioned drawbacks of conventional desalination technologies. The present disclosure provides, for the first time, submerged membrane modules for use for desalination of water. In one or more aspects, the membrane modules can be submerged either in a feed solution tank or the feed solution can pass through the lumen side of the membrane submerged within the tank. The feed solution can be a water-based feed stream containing an amount of salt.

Different MD configurations and different modes of operations such as vertical, horizontal, series and parallel alignments of the modules can be provided to enhance the efficiency of the process. In one or more aspects the feed flow can be reversed to increase the process performance.

Previous approaches concentrated on wastewater treatment according to the conventional membrane bioreactors. We have discovered, for example, that a membrane module, such as hydrophobic microporous flat sheets or hollow fiber membrane bundles, can be submerged into either a hot feed tank or a tank containing coolant. In one or more aspects, the coolant can be cold water. Different configurations of MD process, such as direct contact membrane distillation (DCMD), vacuum membrane distillation (VMD) and sweeping gas membrane distillation (SGMD), can be employed. In the former case a membrane module can be submerged within hot feed, and a coolant stream, sweeping gas or vacuum can be applied through the lumen side of the membrane module, for example hollow fiber membranes or through the space between the two active faces of flat sheet membranes. In the latter case a membrane module can be submerged within a coolant and a hot feed stream can be passed through the lumen side of the membrane module, for example hollow fiber membranes or through the space between the two active faces of flat sheet membranes.

However, stagnant fluid in which the membrane bundles are submerged can cause a quick development of temperature and concentration polarization effects at the membrane interface which can reduce the flux and increase the fouling potential of the membrane. Air scouring or bubble generators can be provided to act as turbulence promoters to minimize the temperature polarization and concentration polarization effects during the process. Moreover, spacers can be used as membrane support and turbulence promoters in the flat sheet membrane modules.

Our submerged configurations of MD can be much more beneficial than conventional processes because they can reduce the critical conventional seawater desalination processes such as MSF and RO challenges in the module fabrication.

In an embodiment, the present disclosure provides a method of membrane distillation. The method comprises the steps of:
a) providing a membrane distillation module within a tank, the tank including an outlet, the membrane module formed at least in part of a hydrophobic microporous material and including a passageway within the material and an outlet in communication with the passageway;
b) providing a feed stream to either the tank or to the passageway of the membrane module, the feed stream including water;
c) heating the feed stream to cause formation of water vapor;
d) providing a difference in partial vapor pressure across the material of the membrane module between the passageway and a side of the material exterior of the membrane module and opposite the passageway to drive the water vapor through the material of the membrane module as permeate and passing the water vapor permeate through the material of the membrane module; and
e) passing the water vapor out of the outlet of one of the tank or the membrane module;
wherein the membrane module is submerged within the tank in at least one of the feed stream or a coolant.

In an embodiment, a system is provided comprising: a) a tank and a membrane distillation module within the tank, the tank including an outlet, the membrane module formed at least in part of a hydrophobic microporous material and including a passageway within the material and an outlet in communication with the passageway; b) a feed stream in communication with either the tank or to the passageway of the membrane module, the feed stream including water and an amount of a salt; c) a heater to heat the feed stream to cause formation of water vapor, the heater configured to provide heat sufficient to provide a difference in partial vapor pressure across the material of the membrane module between the passageway and a side of the material exterior of the membrane module and opposite the passageway to drive the water vapor through the material of the membrane module as permeate and passing the water vapor permeate through the material of the membrane module; and d) a conduit for passing the water vapor out of the outlet of one of the tank or the membrane module; wherein the membrane module is submerged within the tank in at least one of the feed stream or a coolant.

In any one or more aspects, the feed stream can be a water-based stream containing an amount of a salt. For example the feed stream can be selected from the group consisting of seawater, brackish water, urban run-off water, thermal brines, industrial or pretreated domestic waste water (such as that including produced water), and combinations thereof. The coolant can be selected from the group consisting of cold water and fresh water. The heat source can be selected from the group consisting of a renewable energy source and a waste heat source. The renewable energy source can be selected from the group consisting of solar, wind and geothermal energies. A combination of the heating of the feed steam and the coolant, sweeping gas or vacuum can be used to provide the difference in the partial vapor pressure across the material of the membrane module. The water vapor, or permeate, can be condensed to recover fresh water. Heat from the step of condensing the water can be used to heat the feed stream provided into either the tank or the membrane module. The tank can include a turbulence promoter and need not be a membrane bioreactor.

In an embodiment, the tank can include an inlet and the membrane module can include an inlet and the feed stream can be passed into the tank through the tank inlet and out of the tank through the tank outlet, and either a coolant or a sweeping gas can be passed into the passageway of the membrane module through the membrane module inlet and out of the passageway of the membrane module through the membrane module outlet, the water vapor passing through the material of the membrane module from outside of the membrane module through the material of the membrane module into the passageway of the membrane module as water vapor permeate, the coolant or sweeping gas picking up the water vapor permeate from the passageway of the membrane module and delivering the water vapor permeate for collection.

In an embodiment, the tank can include an inlet and the feed stream can be passed into the tank through the tank inlet and out of the tank through the tank outlet, and vacuum can be applied to the passageway of the membrane module through the membrane module outlet, the water vapor passing through the material of the membrane module from outside of the membrane module through the material of the membrane module into the passageway of the membrane module as water vapor permeate, the vacuum drawing the water vapor permeate from the passageway of the membrane module and delivering the water vapor permeate for collection.

In an embodiment, the tank can include an inlet and the membrane module can include an inlet and the feed stream can be passed into the passageway of the membrane module through the membrane module inlet and out of the passageway of the membrane module through the membrane module outlet, and a coolant can be passed into the tank through the tank inlet and out of the tank through the tank outlet, the water vapor passing through the material of the membrane module from the passageway inside of the membrane module out through the material of the membrane module into an interior of the tank as water vapor permeate, the coolant picking up the water vapor permeate from the interior of the tank and delivering the water vapor permeate for collection. In an aspect, a reservoir can be provided for receiving feed stream passed out of the membrane module and for heating feed stream in the reservoir and then delivering heated feed stream from the reservoir back into the passageway of the membrane module.

In any one or more of the foregoing embodiments, the membrane module can be formed of a plurality of hollow fibers providing lumens forming the passageway within the membrane module. The membrane module can be formed of one or more pairs of opposed sheets, each pair of opposed sheets providing a space there between forming the passageway with the membrane module.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is schematic diagram of an embodiment of a submerged SGMD or DCMD process with the membrane modules submerged in a hot feed solution.

FIG. 2 is schematic diagram of an embodiment of a submerged VMD process with the membrane modules submerged in a hot feed solution.

FIG. 3 is schematic diagram of an embodiment of a submerged DCMD process with a hot feed solution introduced into the lumen side of the membrane.

FIGS. 4(a) and (b) depict embodiments of submerged flat sheet membrane modules in (a) parallel and (b) series modes.

FIGS. 5(a)-(f) depict SEM images of PTFE membrane: Cross-section ((a) and (b)), outer surface ((c) and (d)), and inner surface ((e) and (f)).

FIGS. 6(a) and (b) depict a water vapor flux profile vs. feed inlet temperature during (a) co-current and counter-current DCMD process and (b) co-current DCMD and submerged MD process.

### DETAILED DESCRIPTION

Described below are various embodiments of the present systems and methods for submerged membrane distillation for seawater desalination. Although particular embodiments are described, those embodiments are mere exemplary implementations of the system and method. One skilled in the art will recognize other embodiments are possible. All such embodiments are intended to fall within the scope of this disclosure. Moreover, all references cited herein are intended to be and are hereby incorporated by reference into this disclosure as if fully set forth herein. While the disclosure will now be described in reference to the above drawings, there is no intent to limit it to the embodiment or embodiments disclosed herein. On the contrary, the intent is to cover all alternatives, modifications and equivalents included within the spirit and scope of the disclosure.

### Discussion

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, synthetic inorganic chemistry, analytical chemistry, and the like, which are within the skill of the art. Such techniques are explained fully in the literature.

It is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

### Description

Membrane distillation (MD) is a thermally driven membrane based separation process, considered as one of the technologies that are emerging as alternative desalination processes. MD utilizes a hydrophobic, microporous membrane as a contactor to achieve separation by liquid-vapor equilibrium. A pre-heated feed solution can be brought into contact with the membrane which allows only the water vapor to go through the membrane pores so that it condenses on the other side of the membrane. This vapor can be driven across the membrane by the difference in the partial vapor pressure maintained at the two sides of the membrane. MD can operate at ambient pressure and lower temperatures (for example, 40-70° C.) so that any low grade heat source (solar, waste heat, and geothermal) can be sufficient for its operation. Moreover the scalability, inexpensive polymeric materials for the installation, and theoretically 100% salt rejection make MD an attractive desalination process.

In various embodiments, we provide a submerged membrane distillation (SMD) system and process for fresh water production. Fresh water can be produced from, a water-based stream containing an amount of a salt. For example, fresh water can be produced from sea water brines (such as thermal brines), urban run-off, brackish water and/or waste water (such as industrial/domestic waste water including produced water). The process can use commercially available hollow fiber membranes or flat sheet membranes. It has been successfully employed and compared with the conventional direct contact membrane distillation (DCMD) process.

In various embodiments of our SMD process, a plurality of hollow fiber membranes can be combined together, for example by glue, at their ends to provide a simplified open membrane module assembly, having an interior passageway, submerged within a tank or container. The tank can be equipped with a turbulence promoter, such as a mechanical stirrer or a bubble generator. A hot feed stream can be allowed to pass through the tank on the outside or exterior of the membrane module, the membrane module submerged within the feed solution within the tank, while a coolant or sweeping gas can be allowed to pass through the interior passageway of the membrane module or a vacuum can be applied to the interior passageway. Alternatively a hot feed stream can be allowed to pass through the passageway (lumen side of the hollow fibers) of the membrane module, for example using a feed pump, while a coolant can be allowed to pass through the interior of the tank on the outside or exterior of the membrane module, the membrane module submerged within the coolant within the tank. The coolant can be water, for example fresh water. In one or more aspects the temperature of the heated feed stream can range from about 40° C. to about 80° C. The coolant can be at ambient temperature, for example in the range of about 20° C. to about 25° C. In one or more aspects, the temperature different across the membrane(s) of the membrane module can be approximately 5° C. Turbulence in the tank can reduce temperature and concentration polarization on the outside of the membrane module.

The conventional DCMD process, using feed-coolant streams with co-current and counter-current flows has been tested and the results are compared herein. In our SMD process, a water vapor flux of up to 10.2 kg m⁻²h⁻¹ can be achieved when, for example, using a feed inlet temperature of 80° C. and coolant temperature of 20° C. Under the same conditions, during conventional DCMD process, a water vapor flux of 11.6 and 10.1 kg m−2h−1 were observed during counter-current and co-current flow streams, respectively. Results show that the water production in the SMD process is comparable with the conventional DCMD process, while the feed-coolant flow streams are in the co-current direction. During conventional DCMD operation, a 15% increase in the water production is observed when feed-coolant streams are in the counter-current direction compared to the co-current direction.

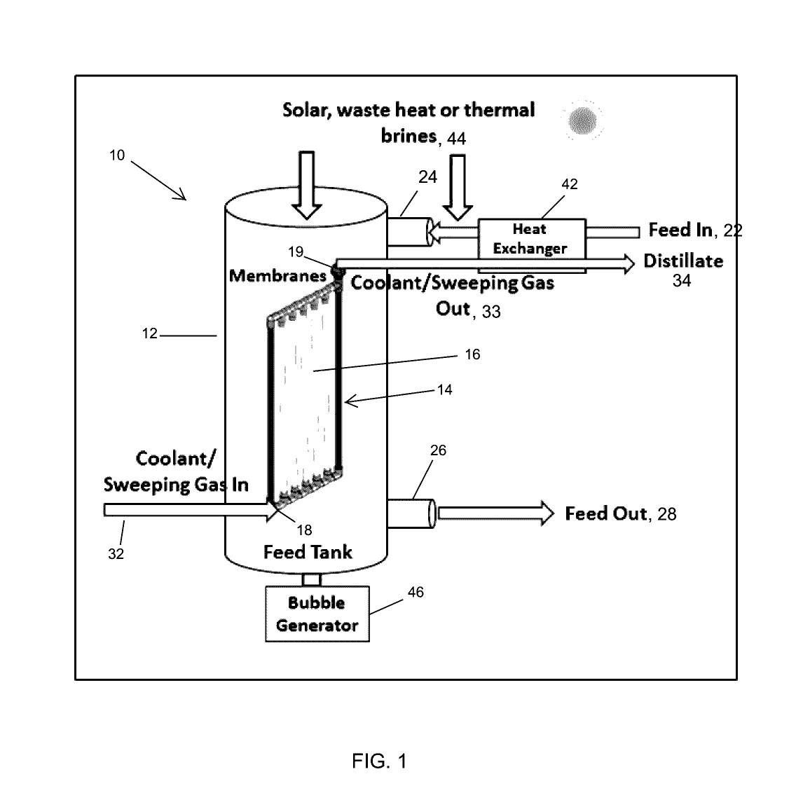

FIG. 1 shows an embodiment of our submerged membrane distillation system and process where, one or more membrane modules are submerged in a hot feed stream. The system 10 can include a tank or reservoir 12 and a membrane module 14 (or a plurality of membrane modules) contained within the tank 12. The tank need not be a membrane bioreactor. The tank includes an inlet 24 for a feed stream 22 and an outlet 26 through which the feed stream can pass out of the tank 12 as a feed out stream 28. The tank 12 can be configured to retain a sufficient amount of feed such that the membrane module 14 is completely submerged within the feed in the tank 12. A heat exchanger 42 can be provided to heat the feed inlet stream 22 before entering the tank inlet 24. A heat source 44 can also be provided to heat the feed inlet stream 22 and/or heat the feed contained within tank 12.

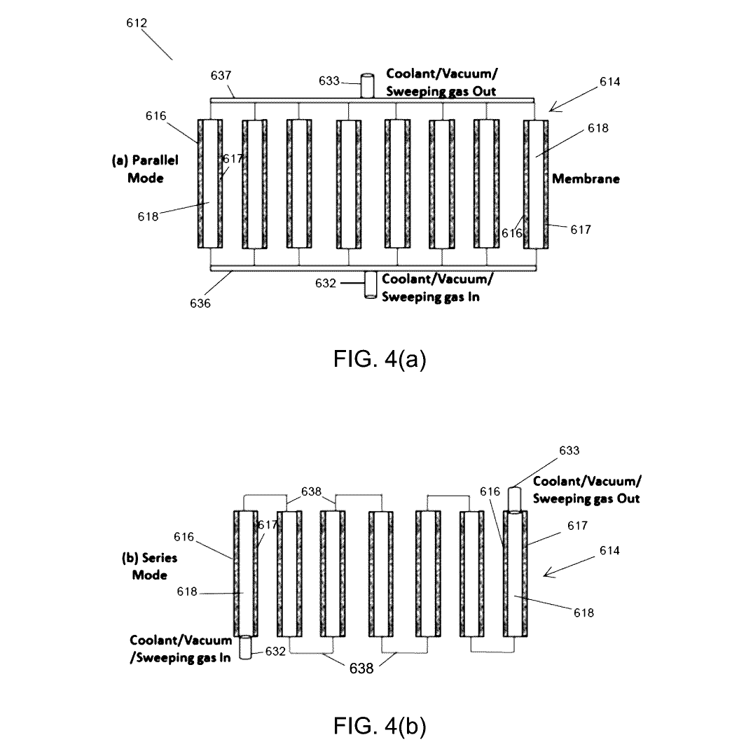

In this embodiment, the membrane module 14 can include one or more hollow membrane fibers 16 providing one or more lumens forming a passageway through the interior of the membrane module 14. The hollow fibers 16 can be spaced apart and parallel to each other. The fibers can be connected on their inlet ends and their outlet ends, respectively, by a common manifold (in a manner similar to the embodiment in FIG. 4(d)). The membrane module 14 further includes an inlet 18 and an outlet 19. In the embodiment depicted, a coolant or sweeping gas 32 can be delivered to the inlet 18 of the membrane module and can pass out through outlet 19 of the module. The hollow fibers 16 can each provide a lumen, or a hollow central portion within the fiber, through which the coolant and/or sweeping gas may pass as it enters and exits the membrane module 14.

The membrane module 14 can be made of any number of materials that allow a gas, such as water vapor, to pass through the material as permeate. High hydrophobic nature of the membrane can prevent membrane wetting allow only water vapor to pass from hot stream through the pores, which condenses at the other side of the membrane and results in ultra-pure quality water production [4,6-14]. For example, the membrane material can be made of a hydrophobic micro porous material. Suitable examples include polytetrafluoroethylene (PTFE), polypropylene (PP), polyethylene (PE), polyvinylidine fluoride (PVDF), polyazoles or any other hydrophobic materials).

The system can include a turbulence promoter 46, such as a bubble generator, to minimize temperature polarization and concentration polarization effects within the tank 12 and more particularly within the feed 22 contained within the tank. An air scouring device or other turbulence promoter can be provided in place of bubble generator 46.

In operation, a coolant or a sweeping gas can be passed through the lumen sides of the hollow fibers of the membrane module, namely through the inner hollow portions of the fiber membranes. The coolant or sweeping gas can be relatively cooler than the feed in the tank thus creating a “cold side” in the lumen sides in the system. If needed, a chiller can be provided to adjust the temperature of the coolant or sweeping gas. The feed source 22 can be heated with any heat source, for example any kind of renewable energy source such as solar, wind or geothermal energies or waste heat from power plants or any other industries. The heated feed in the tank thus provides a “hot side” in the system relative to the coolant or sweeping gas in the lumen sides of the membrane module 14. The feed stream 22 can be for example seawater, brackish water, urban run-offs, brines (such as thermal brines), brackish water, or any kind of industrial or pretreated domestic waste water (such as that including produced water).

A partial vapor pressure created due to the trans membrane temperature is a driving force in an MD process, that would drive water vapor from the feed side or hot side to the cold side of the system through the membrane pores as permeate and condense the water vapor at the cold side of the membrane. The latent heat generated during the evaporation-condensation process can heat the cold side within the lumen sides of the membrane. This heat can be recovered using heat exchanger 42 and can be utilized to heat the feed in solution 22. Cold distillate 34 or product water can be collected from the coolant/sweeping gas out stream 33 exiting outlet 19 of the membrane module 14. The preheated feed in solution 22 can be heated again according to the requirements of the process using the above mentioned waste heat sources 44.

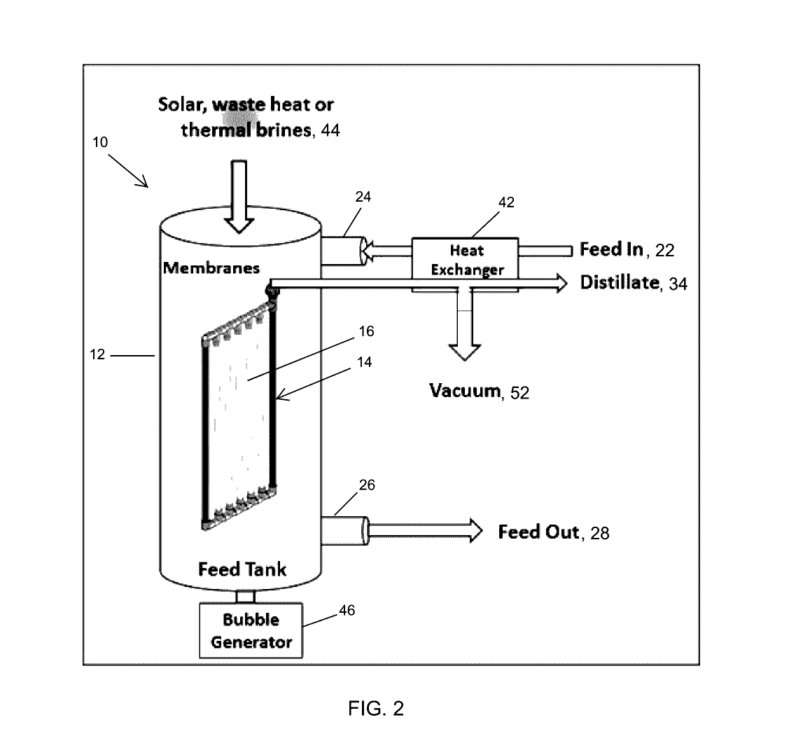

FIG. 2 is a schematic diagram of another embodiment of our submerged MD process. Similar to the embodiment of FIG. 1, this embodiment includes a tank 12 within which is contained a membrane module 14 comprised of a plurality of hollow fibers 16. The tank includes an inlet 24 through which a feed instream 22 may pass into the tank and an outlet 26 through which a feed out stream 28 may pass. The tank 12 can be configured to retain a sufficient amount of feed such that the membrane module 14 is completely submerged within the feed in the tank 12. A heat exchanger 42 can be provided to heat the feed in stream 22 before it enters inlet 24 of the tank. A heat source 44 can be provided to heat the feed stream 22 before and/or after it enters tank 12. A turbulence promoter 46, for example a bubble generator can also be provided. Membrane module 14 can include an outlet 19 for removing condensed permeate, in the form of distillate 34 from the hollow portions or lumens of the hollow fibers 16. A vacuum system 52 can be provided to draw vacuum on the distillate outlet stream. In one or more aspects, the applied vacuum at a particular point can be less than the saturation pressure of the feed solution temperature at that point.

In this embodiment, vacuum can be used on the lumen sides of the membrane module 14 instead of the coolant or sweeping gas used in the above mentioned submerged MD mode in FIG. 2, thus providing a submerged vacuum membrane distillation (VMD) process. The heat exchanger can be a condenser, and the latent heat of condensation can be utilized to preheat the feed solution 22.

The tank 12 and membrane module 14 of the embodiments of FIGS. 1 and 2 can be configured as one stage in a system including a plurality of such stages. For example, feed out 28 from the membrane module 14 can be provided as the feed in to one or more similar stages aligned in series or in parallel, and the feed in 22 can be provided from the feed out of another stage, until the temperature or concentration of the feed limits the MD process performance and efficiency are met.

In further embodiments the hot feed in stream 22 can be passed through the lumen sides of the membrane module 14 by submerging the membrane module in a closed tank or container 12 filled with coolant.

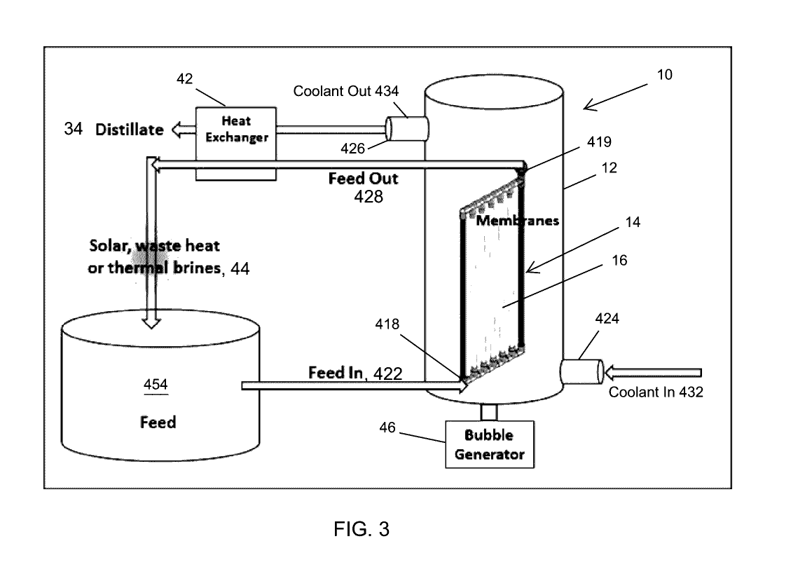

A schematic diagram of an embodiment of such a system is shown in FIG. 3. FIG. 3 depicts an embodiment of the system 10 including tank or container 12, membrane module 14 including a plurality of hollow fibers 16 contained within the tank 12, and the tank including an inlet 424 and an outlet 426 along with an optional turbulence promoter 46. A coolant 432 can be passed into tank 12 through inlet 424 and coolant 434 can exit the tank through outlet 426 thus forming the “cold side” of the process in the tank 12. The membrane module 14 can thereby be submerged within the coolant. The feed stream 422 can be passed through the hollow portions or lumens of the hollow fibers 16 through inlet 418 of the membrane module 14 and out of the membrane module outlet 419, thus forming the “hot side” of the process in the lumen side of the membrane module 14. A heat exchanger 42 can be provided to draw heat from the coolant passing out of the tank 12. Distillate 34 can be then collected from this outlet stream. The feed out can be passed to a storage tank 454 where the feed may be heated by heat source 44 prior to being passed back to the membrane module 14. Thus, the system of FIG. 3 is similar to that of FIG. 1, however, with the hot feed stream being passed through and out of the membrane module 14, while the coolant can be passed into and out of tank 12, resulting in a reversal of the “hot side” and “cold side” of the system in FIG. 1.

One skilled in the art will recognize the membrane module of any of our embodiments can be placed in a horizontal position, a vertical position, or in any position in between. It may be preferable to feed the coolant/sweeping gas from the bottom side of the membrane module to avoid entrapment of air bubbles inside the membrane module.

FIGS. 4 (a) and (b) show further embodiments of our system and process wherein the membrane module is a submerged sheet membrane module 614 either in parallel and series modes, respectively. Parallel and series modes can be applicable in the above hollow fiber membrane module embodiments depending upon the characteristics of the membrane/modules and specifications of the setup such as liquid entry pressure (LEP), flow rates of feed, coolant and sweeping gas through the membrane and vacuum. The embodiment of the sheet membrane module 614 can include one or more pairs of sheet membranes 616, 617 that are opposed and spaced apart from each other to provide hollow space(s) 618 between the pair(s) of sheets, the space(s) 618 providing a passageway through the interior of the membrane module 614.

In the parallel mode of FIG. 4(a) the membrane module 614 includes an inlet 632 and an outlet 633. Inlet 632 leads to a first manifold 636 that is common to and in communication with the space(s) 618 between each pair of membrane sheets 616, 617. The membrane module 614 further includes a second manifold 637 which also is common to and in communication with the hollow space(s) 618 that leads to outlet 633. The membrane modules 614 depicted in FIG. 4 can be used in place of membrane module 14 described in the above embodiments. As depicted in FIG. 4(a) coolant or sweeping gas can be provided to inlet 632 and removed from module 614 by way of outlet 633. Similarly a vacuum can be applied by vacuum system 52 to the module as, for example, depicted in FIG. 2 above.

In the series mode embodiment of FIG. 4(b) manifolds 636 and 637 are replaced by conduits 638 connecting the hollow space(s) 618 of the pairs of membrane sheets in series. Inlets 632 and outlet 633 are provided as in FIG. 4(a) to allow for passage of coolant or sweeping gas through the hollow portion(s) 618 of the membrane module 614, or is in the case of the embodiment applying vacuum 52 in place of coolant or sweeping gas, to draw vacuum on the module. Further, as noted above, the streams as depicted in FIGS. 4(a) and 4(b) can be reversed such that the feed can be passed through the hollow portions 618 of the membrane module 614, as for example in FIG. 3. The distance between the membrane sheets, packing density and membrane area can be varied. At particular time intervals an arrangement to reverse the feed and coolant streams can also be used to enhance the process performance.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is in bar. Standard temperature and pressure are defined as 0° C. and 1 bar.

### EXAMPLES

Commercially available hydrophobic PTFE hollow fiber membranes with a nominal pore size of 0.2 μm, outer diameter of 2 mm, and a wall thickness of 0.5 mm were tested in DCMD and SMD configurations. Red Sea water was used as feed solution in all experiments. Sea water was collected from the King Abdullah University of Science and Technology (KAUST) seawater reverse osmosis plant and filtered through a 10 -μm filter to remove suspended solids prior to the MD process. Tap water was used as a coolant in both DCMD and SMD experiments.

A bunch of hollow fiber membranes were glued together at both the ends to get an open membrane module assembly and simply submerged in to the permeate tank equipped with a mechanical stirrer. Hot feed stream was allowed to pass through the lumen side of the membrane using a peristaltic pump. Continuous stirring at the coolant side helped to uniform the temperature and reduce the temperature, and concentration polarization effects at the outer surface of the hollow fiber membrane. Active surface area of the membrane was calculated to be 0.0075m². Seawater was preheated and fed into the lumen side of the membrane in both the DCMD and SMD configurations using an electric heater. Feed/coolant flow rates were kept at 1.5 Lmin−1 in all experiments. Temperature of the tap water in the permeate tank is controlled using an electric chiller. In both the DCMD and the SMD processes, the flux is calculated by recording the increase in the weight of the permeate overflow from the coolant tank using a weighing balance as a function of time at different feed inlet temperatures (40-80° C.). Conductivity of the permeate was continuously monitored during DCMD and SMD processes using a conductivity meter (Oakton Instruments, Malaysia).

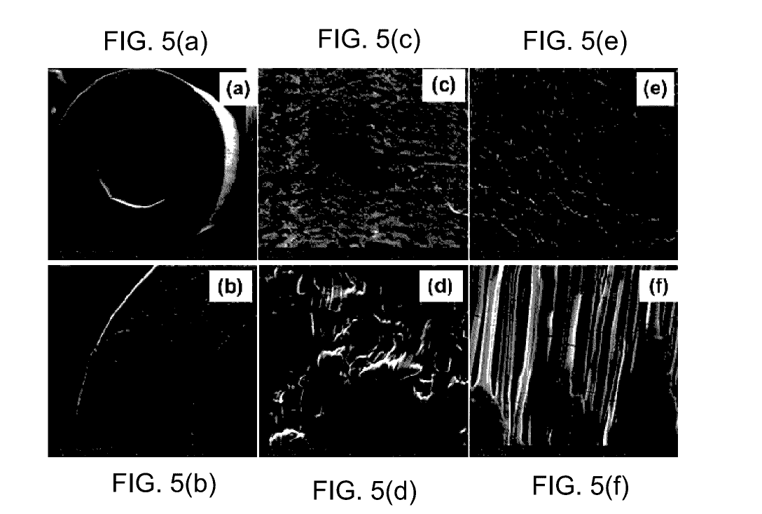

FIGS. 5(a)-(f) show the SEM images of cross-section (FIGS. 5(a) and (b)), outer surface (FIGS. 5(c) and (d)), and inner surface (FIGS. 5(e) and (f)) of the PTFE hollow fiber membranes. Liquid entry pressure and nominal pore size of the membrane is given as 18 psig and 0.2 μm, respectively. The wall thickness of the membrane is higher compared to the conventional membranes used for MD process [19-24]. High membrane thickness causes higher mass transfer resistance and lowers the water flux during the MD process. SEM morphology also reveals that the membrane is less porous and pores are generated as a result of stretching during the fabrication in the form of cracks on the membrane material. Low magnification shows a smoother surface, whereas the high magnification of inner surface shows a fibril structure, and the outer surface shows a porous structure.

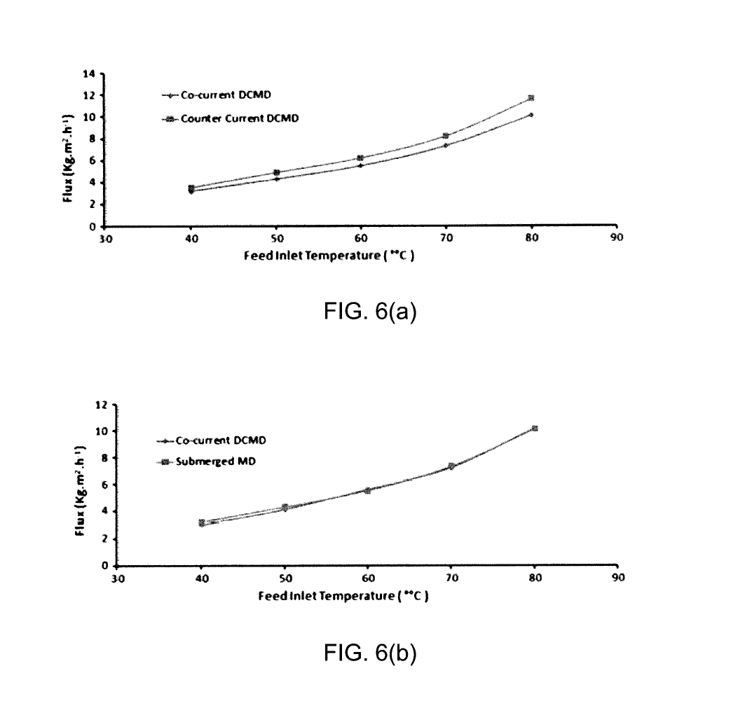

Coolant from a chiller is passed through a glass coil in the permeate tank to control the temperature of the tap water. SMD configuration is an easy way of the fabrication of membrane modules, which avoids the complex design and fabrication processes. Partial water vapor pressure difference across the membrane is the driving force in the MD processes, which drives the water vapors from the hot feed side to the coolant side across the membrane and allows the vapors to condense along with the tap water. As a result, the volume of the permeate tank increases and excess volume generated is collected through an overflow connection into a beaker placed on a weighing balance. Water vapor flux is calculated using the following equation.

$$J = \frac{W}{{A}_{t}} \qquad ( 1 )$$

where J is the water vapor flux, W is the weight of permeate collected during a time interval (h), and A is the active area of the membrane (m²). Water vapor flux comparison during countercurrent and co-current feed streams at different feed inlet temperatures during the DCMD process is plotted in FIG. 6(a). FIG. 6(b) shows the comparison between the water vapor flux during the DCMD and SMD processes. The water vapor flux during co-current DCMD and SMD was found to be 10.1 and 10.2 kgm−2h−1, respectively, at a feed inlet temperature of 80° C. and at a coolant inlet temperature of 20° C. The water vapor flux during counter-current DCMD was determined to be 11.6 kgm−2h−1 at a feed inlet temperature of 80° C. and at a coolant inlet temperature of 20° C.

In the SMD process, a water vapor flux of 10.2 kgm−2h−1 is observed when using a feed inlet temperature of 80° C. and coolant temperature of 20° C. Under similar conditions, during the conventional DCMD process, a water vapor flux of 11.6 and 10.1 kgm−2h−1 was observed during counter-current and co-current flow streams, respectively. There is a possibility of less turbulence in the SMD process at the coolant side than that in the conventional DCMD process, which may result in a more temperature polarization at the outer surface of the membrane. During the MD process, the temperature polarization at the coolant side or at lower temperatures has negligible influence on the effective transmembrane vapor pressure and water vapor flux compared to the feed side [25].

Results showed that the water production in the SMD process is comparable to that of conventional DCMD process, while the feed-coolant flow streams are in co-current direction. During conventional DCMD operation, a 15% increase in the water production is observed when feed-coolant streams are in the counter-current direction compared to the co-current direction. It was observed that the water flux during the DCMD and SMD processes using PTFE hollow fiber membrane is much less than that of the flux observed during the DCMD process using PTFE and other types of flat sheet membranes under the same operating conditions, as reported in previous studies [25-27]. This is due to the different membrane characteristics, especially the thickness and pore size distribution of the membranes. Conductivity of the tap water in the permeate tank was observed to be decreasing with time during all experiments. This is due to the high quality of water vapors passing from the feed side to the permeate tank by rejecting all non-volatiles at the feed side. The heat and mass transfer during the present study is low due to the increased wall thickness and less porous structure of the membrane. Membrane modules in the SMD design is similar to the membrane bioreactors (MBRs), and it is possible to adapt MD membranes in MBR process to extract fresh water from wastewater and concentrate the nutrients, simultaneously. Engineered membrane design is necessary to make the membrane more appropriate for optimum MD process.

Our SMD process was successfully employed, tested, and compared with the conventional DCMD process using commercially available PTFE hollow fiber membranes. A 15% increase in the water vapor flux is observed when feed-coolant streams are in the counter-current direction compared to the co-current direction, whereas the water production in the SMD process is comparable with the conventional DCMD process while the feed-coolant flow streams are in the co-current direction. SMD module design is much simpler than the conventional DCMD modules and it is possible to use this design in MBRs to reduce the volume of wastewater by extracting fresh water using the MD process.

Ratios, concentrations, amounts, and other numerical data may be expressed in a range format. It is to be understood that such a range format is used for convenience and brevity, and should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1% to about 5%, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to significant figure of the numerical value. In addition, the phrase “about ‘x’ to ‘y’” includes “about ‘x’ to about ‘y’”.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

### REFERENCES

[1] G. C. Sarti, C. Gostoli, S. Matulli, Low energy cost desalination processes using hydrophobic membranes, Desalination 56 (1985) 277-286.
[2] L. Camacho, L. Dume'e, J. Zhang, J.-D. Li, M. Duke, J. Gomez, S. Gray, Advances in membrane distillation for water desalination and purification applications, Water 5 (2013) 94-196.
[3] A. G. Fane, R. W. Schofield, C. J. D. Fell, The efficient use of energy in membrane distillation, Desalination 64 (1987) 231-243.
[4] L. Francis, N. Ghaffour, A. A. Alsaadi, G. L. Amy, Material gap membrane distillation: A new design for water vapor flux enhancement, J. Membr. Sci. 448 (2013) 240-247.
[5] A. Alkhudhiri, N. Darwish, N. Hilal, Membrane distillation: A comprehensive review, Desalination 287 (2012) 2-18.
[6] K. W. Lawson, D. R. Lloyd, Membrane distillation, J. Membr. Sci. 124(1) (1997) 1-25.
[7] S. T. Hsu, K. T. Cheng, J.S. Chiou, Seawater desalination by direct contact membrane distillation, Desalination 143(3) (2002) 279-287.
[8] A. M. Alklaibi, N. Lior, Membrane-distillation desalination: Status and potential, Desalination 171 (2005) 111-131.
[9] M. Khayet, N. N. Li, A. G. Fane, W. S. Winston Ho, Membrane Distillation, Advance Membrane Technology and Applications, John Wley, Hoboken, N.J., 2008.
[10] M. S. El-Bourawi, Z. Ding, R. Ma, M. Khayet, A framework for better understanding membrane distillation separation process, J. Membr. Sci. 285(1-2) (2006) 4-29.
[11] S. Bonyadi, T. S. Chung, Highly porous and macrovoidfree PVDF hollow fiber membranes for membrane distillation by a solvent-dope solution co-extrusion approach, J. Membr. Sci. 331(1-2) (2009) 66-74.
[12] A. S. Alsaadi, N. Ghaffour, J. D. Li, S. Gray, L. Francis, H. Maab, G. L. Amy, Modeling of air-gap membrane distillation process: A theoretical and experimental study, J. Membr. Sci. 445 (2013) 53-65.
[13] L. Francis, N. Ghaffour A. S. Alsaadi, G. L. Amy, Performance of different hollow fiber membranes for seawater desalination using membrane distillation, Desalin. Water. Treat. Accepted (2014), doi: 10.1080/ 19443994.2014.946723.
[14] L. Francis, N. Ghaffour, G. Amy, Fabrication and characterization of functionally graded poly(vinylidine fluoride)-silver nanocomposite hollow fibers for sustainable water recovery, Sci. Adv. Mater. Accepted (2014), doi: 10.1166/sam.2014.1980.
[15] K. Y. Wang, T. S. Chung, M. Gryta, Hydrophobic PVDF hollow fiber membranes with narrow pore size distribution and ultra-thin skin for the fresh water production through membrane distillation, Chem. Eng. Sci. 63(9) (2008) 2587-2594.
[16] K. Y. Wang, S. W. Foo, T. S. Chung, Mixed matrix PVDF hollow fiber membranes with nanoscale pores for desalination through direct contact membrane distillation, Ind. Eng. Chem. Res. 48 (2009) 4474-4483.
[17] C. Y. Feng, K. C. Khulbe, T. Matsuura, A. F. Ismail, Recent progresses in polymeric hollow fiber membrane preparation, characterization and applications, Separ. Purific. Technol. 111 (2013) 43-71.
[18] X. Yang, R. Wang, L. Shi, A. G. Fane, M. Debowski, Performance improvement of PVDF hollow fiberbased membrane distillation process, J. Membr. Sci. 369(1-2) (2011) 437-447.
[19] H. Maab, A. Al Saadi, L. Francis, S. Livazovic, N. Ghafour, G. L. Amy, S. P. Nunes, Polyazole hollow fiber membranes for direct contact membrane distillation, Ind. Eng. Chem. Res. 52 (2013) 10425-10429.
[20] F. F. Shao, L. Ni, Y. F. Zhang, Y. B. Chen, Z. Liu, Z. Cao, Study on vacuum membrane distillation of PP hollow fiber membranes used in concentrated seawater from low-pressure reverse osmosis, Desalin. Water Treat. 51 (2013) 3925-3929.
[21] B. Wu, X. Y. Tan, K. Li, W. K. Teo, Removal of 1,1,1-trichloroethane from water using a polyvinylidene fluoride hollow fiber membrane module: Vacuum membrane distillation operation, Sep. Purif. Technol. 52 (2006) 301-309.
[22] L. Francis, N. Ghaffour, A. AlSaadi, S. Nunes, G. Amy, PVDF hollow fiber and nanofibers membranes for fresh water reclamation using membrane distillation, J. Mater. Sci. 49 (2014) 2045-2053.
[23] N. Peng, N. Wdjojo, P. Sukitpaneenit, M. M. Teoh, G. G. Lipscomb, T. S. Chung, J. Y. Lai, Evolution of polymeric hollow fibers as sustainable technologies: Past, present and future, Prog. Polym. Sci. 37 (2012) 1401-1424.
[24] L. Shi, R. Wang, Y. Cao, C. Feng, D. T. Liang, J. H. Tay, Fabrication of poly(vinylidine fluoride-co-hexafluropylene) (PVDF-HFP) asymmetric microporous hollow fiber membranes, J. Membr. Sci. 305(1-2) (2007) 215-225.
[25] L. Francis, H. Maab, A. AlSaadi, S. Nunes, N. Ghaffour, G. L. Amy, Fabrication of electrospun nanofibrous membranes for membrane distillation application, Desalin. Water. Treat. 51(7-9) (2013) 1337-1343.
[26] H. Maab, L. Francis, A. S. Al-saadi, C. Aubry, N. Ghaffour, G. L. Amy, S. P. Nunes, Synthesis and fabrication of nanostructured hydrophobic polyazole membranes for low-energy water recovery, J. Membr. Sci. 423-424 (2012) 11-19.
[27] L. Francis, N. Ghaffour, A. S. Alsaadi, S. P. Nunes, Performance evaluation of the DCMD desalination process under bench scale and large scale module operating conditions, J. Membr. Sci. 455 (2014) 103-112.

We claim:

1. A method of membrane distillation, comprising the steps of:
a) providing a membrane distillation module within a tank, the tank including an outlet, the membrane module formed at least in part of a hydrophobic microporous material and including a passageway within the material and an outlet in communication with the passageway;
b) providing a feed stream to either the tank or to the passageway of the membrane module, the feed stream including water;
c) heating the feed stream to cause formation of water vapor;
d) providing a difference in partial vapor pressure across the material of the membrane module between the passageway and a side of the material exterior of the membrane module and opposite the passageway to drive the water vapor through the material of the membrane module as permeate and passing the water vapor permeate through the material of the membrane module; and
e) passing the water vapor out of the outlet of one of the tank or the membrane module;
wherein the membrane module is submerged within the tank in at least one of the feed stream or a coolant.

2. The method of claim 1, wherein the feed stream is a water-based stream including an amount of a salt.

3. The method of claim 2, wherein the feed stream is selected from the group consisting of seawater, brackish water, urban run-off water, brines, industrial or pretreated domestic waste water, and combinations thereof

4. The method of claim 1, wherein the coolant is selected from the group consisting of cold water and fresh water.

5. The method of claim 1, wherein the heat source is selected from the group consisting of a renewable energy source and a waste heat source.

6. The method of claim 5, wherein the renewable energy source is selected from the group consisting of solar, wind and geothermal energies.

7. The method of claim 1, wherein. a combination of the heating of the feed steam and the coolant, sweeping gas or vacuum is used to provide the difference in the partial vapor pressure across the material of the membrane module.

8. The method of claim 1, including condensing the water vapor to recover fresh water.

9. The method of claim 8, including transferring heat from the step of condensing the water to heat the feed stream provided into either the tank or the membrane module.

10. The method of claim 1, wherein the tank includes a turbulence promoter.

11. The method of claim 1, wherein the tank includes an inlet and the membrane module includes an inlet and the feed stream is passed into the tank through the tank inlet and out of the tank through the tank outlet, and either a coolant or a sweeping gas is passed into the passageway of the membrane module through the membrane module inlet and out of the passageway of the membrane module through the membrane module outlet, the water vapor passing through the material of the membrane module from outside of the membrane module through the material of the membrane module into the passageway of the membrane module as water vapor permeate, the coolant or sweeping gas picking up the water vapor permeate from the passageway of the membrane module and delivering the water vapor permeate for collection.

12. The method of claim 1, wherein the tank includes an inlet and the feed stream is passed into the tank through the tank inlet and out of the tank through the tank outlet, and vacuum is applied to the passageway of the membrane module through the membrane module outlet, the water vapor passing through the material of the membrane module from outside of the membrane module through the material of the membrane module into the passageway of the membrane module as water vapor permeate, the vacuum drawing the water vapor permeate from the passageway of the membrane module and delivering the water vapor permeate for collection.

13. The method of claim 1, wherein the tank includes an inlet and the membrane module includes an inlet and the feed stream is passed into the passageway of the membrane module through the membrane module inlet and out of the passageway of the membrane module through the membrane module outlet, and a coolant is passed into the tank through the tank inlet and out of the tank through the tank outlet, the water vapor passing through the material of the membrane module from the passageway inside of the membrane module out through the material of the membrane module into an interior of the tank as water vapor permeate, the coolant picking up the water vapor permeate from the interior of the tank and delivering the water vapor permeate for collection.

14. The method of claim 13, including providing a reservoir for receiving feed stream passed out of the membrane module and for heating feed stream in the reservoir and then delivering heated feed stream from the reservoir back into the passageway of the membrane module.

15. The method of claim 1, wherein the membrane module is formed of a plurality of hollow fibers providing lumens forming the passageway within the membrane module.

16. The method of claim 1, wherein, the membrane module is formed of one or more pairs of opposed sheets, each pair of opposed sheets providing a space there between forming the passageway with the membrane module.

17. A system comprising:
a) a tank and a membrane distillation module within the tank, the tank including an outlet, the membrane module formed at least in part of a hydrophobic microporous material and including a passageway within the material and an outlet in communication with the passageway;
b) a feed stream in communication with either the tank or to the passageway of the membrane module, the feed stream including water and an amount of a salt;
c) a heater to heat the feed stream to cause formation of water vapor, the heater configured to provide heat sufficient to provide a difference in partial vapor pressure across the material of the membrane module between the passageway and a side of the material exterior of the membrane module and opposite the passageway to drive the water vapor through the material of the membrane module as permeate and passing the water vapor permeate through the material of the membrane module; and
d) a conduit for passing the water vapor out of the outlet of one of the tank or the membrane module; wherein the membrane module is submerged within the tank in at least one of the feed stream or a coolant.
